(19) United States
(12) Patent Application Publication
(10) Pub. No.: US 2025/0140929 A1
(43) Pub. Date: May 1, 2025

(54) ELECTROLYTE, NIOBIUM BATTERY INCLUDING THE ELECTROLYTE, AND METHOD OF MANUFACTURE THEREOF

(71) Applicant: Nyobolt Limited, Cambridge Cambs (GB)

(72) Inventors: Adam Vurgaropulos, Bedford, MA (US); Rocco Iocco, Bedford, MA (US); Sheel Sanghvi, Bedford, MA (US)

(21) Appl. No.: 18/834,088

(22) PCT Filed: Feb. 3, 2023
(86) PCT No.: PCT/EP2023/052679

§ 371 Date: Jul. 29, 2024

(30) Foreign Application Priority Data
Feb. 4, 2022 (GB) 2201480.7

(51) Int. Cl. H01M 10/0569; H01M 4/02; H01M 4/485; H01M 10/052; H01M 10/0568

(52) U.S. Cl. CPC H01M 10/0569; H01M 4/485; H01M 10/052; H01M 10/0568; H01M 2004/027; H01M 2300/0037; H01M 2300/0051

(57) ABSTRACT

The present invention relates to a secondary battery and a method of preparing a secondary battery, the secondary battery comprising: a positive electrode; a negative electrode comprising a niobium metal oxide; a separator between the positive electrode and the negative electrode; and an electrolyte comprising a solvent composition comprising a dinitrile solvent and at least one second solvent selected from the list consisting of a mononitrile solvent, a carbonate solvent, an ester solvent, or an ether solvent, wherein the dinitrile is contained in an amount of at least 0.1 weight percent, based on a total weight of the solvent composition. The electrolyte supresses gas generation from reaction between the electrolyte and the niobium metal oxide in the negative electrode, improving safety of the battery.

### RELATED APPLICATIONS

This application claims priority to, and the benefit of, GB 2201480.7 filed on 4 Feb. 2022 (4 Feb. 2022), the contents of which are hereby incorporated by reference in their entirety.

### FIELD OF THE INVENTION

The present invention relates to a secondary battery and a method of preparing a secondary battery.

### BACKGROUND

During storage of a niobium battery undesirable gas generation can result. There thus remains a need for improved materials for a niobium-based battery in which gas formation is reduced.

### SUMMARY OF THE INVENTION

Generally, the present invention provides a secondary battery comprising an electrolyte, the electrolyte comprising a solvent composition comprising:
a multinitrile solvent having two or more nitrile groups, and
at least one second solvent selected from the group consisting of a mononitrile solvent, a carbonate solvent, an ester solvent, or an ether solvent,
wherein the multinitrile solvent is contained in an amount of at least 0.1 weight percent, based on a total weight of the solvent composition.

In a first aspect of the invention there is provided a secondary battery, comprising:
a positive electrode;
a negative electrode comprising a niobium oxide or niobium metal oxide;
a separator between the positive electrode and the negative electrode; and
an electrolyte comprising
   a solvent composition comprising:
      a multinitrile solvent having two or more nitrile groups, and
      at least one second solvent selected from the group consisting of a mononitrile solvent, a carbonate solvent, an ester solvent, and an ether solvent,
   wherein the multinitrile solvent is contained in an amount of at least 0.1 weight percent, based on a total weight of the solvent composition.

In a second aspect of the invention there is provided a method of manufacturing a secondary battery, the method comprising:
providing a positive electrode,
providing a negative electrode comprising a niobium oxide or niobium metal oxide, and
providing a separator between the positive electrode and the negative electrode; and
providing an electrolyte comprising
   a solvent composition comprising:
      a multinitrile solvent having two or more nitrile groups, and
      at least one second solvent selected from the group consisting of a mononitrile solvent, carbonate solvent, an ester solvent, or an ether solvent,
   wherein the multinitrile is contained in an amount of at least 0.1 weight percent, based on a total weight of the solvent composition, and
contacting the positive electrode, the negative electrode, and the separator with the electrolyte to manufacture the secondary battery.

In some embodiments, the multinitrile solvent is a dinitrile solvent or trinitrile solvent, such as a dinitrile solvent.

In some embodiments, the electrolyte further comprises a lithium salt.

In some embodiments, the negative electrode comprises a niobium metal oxide.

In a particular embodiment, the multinitrile solvent is a dinitrile solvent, the electrolyte comprises a lithium salt and the negative electrode comprises a niobium metal oxide.

In some embodiments, the invention provides a secondary battery, comprising: a positive electrode; a negative electrode comprising a niobium metal oxide; a separator between the positive electrode and the negative electrode; and an electrolyte comprising a solvent composition comprising a dinitrile solvent and at least one of a carbonate solvent, an ester solvent, or an ether solvent, wherein the dinitrile is contained in an amount of at least 0.1 weight percent, based on a total weight of the solvent composition, and a lithium salt.

In some embodiments, the invention provides a method of manufacturing a secondary battery, the method comprising: providing a positive electrode, providing a negative electrode comprising a niobium metal oxide, and providing a separator between the positive electrode and the negative electrode; and providing an electrolyte comprising a solvent composition comprising a dinitrile solvent and at least one of a carbonate solvent, an ester solvent, or an ether solvent, wherein the dinitrile is contained in an amount of at least 0.1 weight percent, based on a total weight of the solvent composition, and a lithium salt, and contacting the positive electrode, the negative electrode, and the separator with the electrolyte to manufacture the secondary battery.

The above described and other features are exemplified by the following figures and detailed description.

### BRIEF DESCRIPTION OF THE DRAWINGS

The following figures are exemplary embodiments wherein the like elements are numbered alike.

FIG. 1 is a graph showing the volume of gas generated in lithium nickel cobalt aluminium oxide (NCA)/niobium tungsten oxide (NWO) pouch cells during storage of the cells for 7 days at 60° C.

FIG. 2 is a pie chart illustrating the composition of gases generated in an NCA/NWO pouch cell containing an electrolyte without salt.

FIG. 3 is a graph showing the volume of gas generated over time (weeks) for NCA/NWO pouch cells containing electrolytes with different lithium salts.

FIG. 4 is a graph showing the volume of gas generated and the percentage capacity lost in LCO/NWO pouch cells containing different electrolytes following storage of the cells for 14 days at 60° C.

FIG. 5 is a graph showing the volume of gas generated and the percentage capacity lost in LCO/NWO pouch cells containing different electrolytes following storage of the cells for 7 days at 60° C.

FIG. 6 shows the cell volume increase after 2 weeks of storage at 60° C. for LCO/NWO pouch cells containing different electrolyte compositions (Examples 5.1 to 5.5). The black cross corresponds to the mean average volume increase and the shaded area the standard deviation of the volume increase.

FIG. 7 shows the capacity retention after 2 weeks of storage at 60° C. for LCO/NWO pouch cells containing different electrolyte compositions (Examples 5.1 to 5.5). The black cross corresponds to the mean average capacity retention and the shaded area the standard deviation of the capacity retention.

FIG. 8 shows the cell volume increase after 6 weeks of storage at 60° C. for LCO/NWO pouch cells containing different electrolyte compositions (Examples 5.2, 5.4, 5.6 and 5.7). The black cross corresponds to the mean average volume increase and the shaded area the standard deviation of the volume increase.

FIG. 9 shows the capacity retention after 6 weeks of storage at 60° C. for LCO/NWO pouch cells containing different electrolyte compositions (Examples 5.2, 5.4, 5.6 and 5.7). The black cross corresponds to the mean average capacity retention and the shaded area the standard deviation of the capacity retention.

### DETAILED DESCRIPTION OF THE INVENTION

Secondary batteries including a niobium oxide or niobium metal oxide negative electrode produce significant amounts of gas when the cells are in a charged state. It has been discovered that gas generation is affected by the composition of the electrolyte. For example, when the electrolyte includes a cyclic carbonate (e.g., ethylene carbonate) reduction of the cyclic carbonate can occur in the presence of a niobium-based negative electrode. Interactions between the electrolyte and niobium-based negative electrode can result in the reduction of the electrolyte to generate hydrogen and oxygen, particularly when the cells are held in a changed state and/or at elevated temperature. In cells including a niobium oxide or niobium metal oxide negative electrode, the decomposition of the electrolyte can be autocatalytic and involve reaction of a fluorinated salt with residual alcohol or water in the electrolyte solvent and reduction of cyclic carbonate (if present), resulting in gas generation. Generated hydrogen and oxygen accumulate within the battery and can become a hazard.

Cells where the negative electrode potential can be lowered to a voltage suitable to form a solid-electrolyte interphase (SEI) avoid this problem. For example, in cells with graphite-based negative electrode this gassing problem is not present because the solid-electrolyte interphase (SEI) is formed when the negative electrode potential vs. lithium is at a voltage of less than 0.2 volts (V) versus Li. The SEI is understood to passivate the negative electrode surface, avoiding reduction of the electrolyte. However, the SEI is also decomposed or removed at greater potentials, and thus this strategy is not available for niobium-based electrodes because they operate at potentials of greater than 0.2V vs Li.

Also, use of sacrificial additives (e.g., vinylene carbonate, or 1,3-propane sultone) in the electrolyte to encourage the formation of a SEI is not satisfactory for niobium-based negative electrodes because when the cells are charged and discharged, the cells are cycle-swept across a range of reduction-oxidation potentials that results in decomposition of the SEI. Furthermore, the SEI forms a resistive barrier that hinders charge and discharge rates, thereby negatively impacting one of the key attributes of a niobium-based negative electrode.

Disclosed herein are electrolytes that mitigate gas generation and improve safety of a lithium-ion secondary battery including a niobium oxide or niobium metal oxide negative electrode. In particular, it has been advantageously discovered that an electrolyte comprising a multinitrile solvent (e.g., dinitrile or trinitrile) in combination with one or more of carbonate, ester, and/or ether solvents, effectively decreases the amount of gas generated. It is thought that the multinitrile component supresses the decomposition of the electrolyte in niobium metal oxide cells, thus decreasing the amount of gas generated.

In some embodiments, the electrolyte further comprises a lithium salt, such as a lithium salt selected from LiBF₄, LiPF₆, lithium bis(fluorosulfonyl)imide (LiFSI), lithium bis(trifluoromethanesulfonyl)imide (LiTFSI), or a combination thereof and additionally or alternately lithium difluoro(oxalato)borate (LiDOFB)

Furthermore, an electrolyte comprising a multinitrile solvent (e.g., dinitrile or trinitrile) in combination with a lithium salt (e.g., LiBF₄, LiPF₆ or LiDFOB) and one or more carbonate, ester, and/or ether solvents, has been found to further decreases the amount of gas generated. It is thought that the multinitrile solvent and the lithium salt work in synergy to further decrease the electrolyte decomposition and gassing.

As a result of the reduced decomposition of the electrolyte, the invention also results in improved capacity retention for the secondary battery, especially after prolonged storage at elevated temperatures and/or in a charged state.

Some secondary batteries and electrolytes are known, and these are discussed below.

US 2017/0244135 describes an electrochemical cell and a system to restore capacity to the cell. The document describes an electrolyte including various solvents such as carbonates, esters and ethers, lithium salts and additive agents, such as dinitrile. The examples describe a cell including a graphite anode and an electrolyte of ethylene carbonate and LiTFSA (see [3015]). It is known that graphite anodes are not prone to gassing. US 2017/0244135 does not describe niobium metal oxide negative electrode in combination with an electrolyte including a multinitrile. The document does not discuss electrolyte gassing and does not suggest that this specific combination of a multinitrile electrolyte solvent with a niobium (metal) oxide anode is able to reduce gassing.

JP 2013/152825 concerns reducing electrolyte decomposition and gassing. The document suggests gassing can be reduced by using an electrolyte and/or positive electrode including a phosphorous compound, which is able to form a phosphorus oxide film on the anode during cell cycling. The general disclosure mentions lithium titanium niobium oxide anodes and electrolytes including various nitrile components in combination with a phosphorous compound. The examples do not disclose a cell including both a niobium metal oxide anode and a dinitrile containing electrolyte, instead focusing on Li-metal electrodes with polymeric electrolytes. There is no suggestion that dinitriles are particularly effective at reducing gassing for niobium-based anodes. Rather, JP 2013/152825 teaches to use a phosphorous additive to form an SEI on Li-metal electrodes. This is contrary to the present invention which avoids the need for an SEI, enabling better high rate performance of the battery.

WO 2020/047228 relates to coated cathode materials for secondary lithium-ion cells. The document does not provide any examples of complete batteries, only the positive electrode material. The general disclosure mentions electrodes including lithium niobate and electrolytes including nitrile solvents. However, there is no disclosure of a niobium metal oxide anode and dinitrile containing electrolyte used in combination, and there is no mention of using the electrolyte composition to reduce gassing. The document only mentions cathode coatings or pressure relocation systems to address gas formation.

### Electrolyte

The electrolyte disclosed herein comprises a solvent composition. The solvent composition comprises a multinitrile solvent and at least one second solvent selected from the list consisting of a mononitrile solvent, a carbonate solvent, an ester solvent, or an ether solvent.

Typically, the electrolyte is non-aqueous. That is, the electrolyte is substantially free of water. In some embodiments the electrolyte comprises a lithium salt.

The multinitrile solvent is a nitrile containing compound having two or more nitrile groups per molecule. The multinitrile may be a C₃ to C₂₀ aliphatic multinitrile. Typically, the multinitrile comprises from two to five nitrile groups, preferably two to four nitrile groups, more preferably two or three nitrile groups. The multinitrile may be a dinitrile or a trinitrile.

The dinitrile is a C₃ to C₁₀ aliphatic dinitrile, preferably a C₃ to C₁₀ aliphatic linear dinitrile. The aliphatic group of the C₃ to C₁₀ aliphatic dinitrile can be a substituted or unsubstituted C₃ to C₁₀ alkyl, alkenyl, or alkynyl group, or preferably a linear C₃ to C₁₀ alkyl, alkenyl, or alkynyl group. Examples of the C₃ to C₁₀ aliphatic linear dinitrile include glutaronitrile (GN; pentanedinitrile), adiponitrile (ADN; hexanedinitrile), pimelonitrile (PMN; heptanedinitrile), suberonitrile (SUN; octanedinitrile), azelanitrile (AZN; nonanedinitrile), sebaconitrile (SEN; decanedinitrile), or a combination thereof, and additionally or alternately succinonitrile (SN; butanedinitrile),

The trinitrile is a C₄ to C₁₀ aliphatic trinitrile, preferably a C₄ to C₁₀ aliphatic linear trinitrile. The aliphatic group of the C₄ to C₁₀ aliphatic trinitrile can be a substituted or unsubstituted C₄ to C₁₀ alkyl, alkenyl, or alkynyl group, such as a linear C₄ to C₁₀ alkyl, alkenyl, or alkynyl group. Examples of the C₄ to C₁₀ aliphatic linear trinitrile include 1,3,6-hexanetricarbonitrile.

The carbonate solvent comprises a C₃ to C₉ linear carbonate. Examples include dimethyl carbonate (DMC), diethyl carbonate (DEC), dipropyl carbonate (DPC), methyl propyl carbonate (MPC), methyl iso-propyl carbonate, ethyl propyl carbonate (EPC), ethyl iso-propyl carbonate, ethyl methyl carbonate (EMC), methyl ethyl carbonate (MEC), ethylene carbonate (EC), propylene carbonate (PC), butylene carbonate (BC), isobutylene carbonate, monofluoroethylene carbonate (FEC), 4,4-difluoroethylene carbonate, 4,5-difluoroethylene carbonate, or a combination thereof.

In some embodiments the solvent composition comprises a multinitrile solvent and at least one carbonate solvent. Preferably, the carbonate solvent comprises ethylene carbonate (EC), ethyl methyl carbonate (EMC), propylene carbonate (PC) or a combination thereof. More preferably, the solvent composition comprises a mixture of ethylene carbonate and ethyl methyl carbonate, or propylene carbonate and ethyl methyl carbonate.

In some embodiments, the weight ratio of ethylene carbonate to ethyl methyl carbonate is from 30:70 to 50:50. In some embodiments, the weight ratio of propylene carbonate to ethyl methyl carbonate is from 30:70 to 50:50. Preferably the weight ratio is about 30:70.

Preferably, the solvent composition comprises a propylene carbonate (PC) solvent. In some such embodiments, the propylene carbonate is contained in an amount of at least 1 weight percent, based on a total weight of the solvent composition.

The ether solvent comprises dibutyl ether, tetraglyme, diglyme, 1,2-dimethoxyethane, 2-methyl tetrahydrofuran, tetrahydrofuran, or a combination thereof.

The ester solvent comprises a C₃ to C₉ linear ester. Examples include methyl acetate, ethyl acetate, n-propyl acetate, isopropyl acetate, dimethyl acetate, methyl propionate, ethyl propionate, γ-butyrolactone, 5-decanolide, γ-valerolactone, dl-mevalonolactone, γ-caprolactone, or a combination thereof.

The multinitrile solvent (e.g., dinitrile or trinitrile solvent) is contained in the solvent composition in an amount of at least 0.1 weight percent (wt %), such as at least 0.5 wt %, or at least 1 wt %, or at least 5 wt %, or at least 10 wt %. In an aspect, the dinitrile solvent is contained in the solvent composition in an amount 0.1 wt % to 55 wt %, or 0.2 wt % to 50 wt %, or 1 wt % to 45 wt %, or 5 wt % to 40 wt %, or 5 wt % to 30 wt %, or 10 wt % to 30 wt %, or 10 wt % to 25 wt %, or 10 wt % to 20 wt %, based on the total weight of the solvent composition

Preferably, the dinitrile solvent is contained in the solvent composition in an amount of at least 0.1 weight percent (wt %), such as at least 0.5 wt %, or at least 1 wt %, or at least 5 wt %, or at least 10 wt %. In an embodiment, the dinitrile solvent is contained in the solvent composition in an amount 0.1 wt % to 55 wt %, or 0.2 wt % to 50 wt %, or 1 wt % to 45 wt %, or 5 wt % to 40 wt %, or 5 wt % to 30 wt %, or 10 wt % to 30 wt %, or 10 wt % to 25 wt %, or 10 wt % to 20 wt %, based on the total weight of the solvent composition.

In one embodiment, the multinitrile solvent is contained in the solvent composition in an amount of 10 weight percent to 50 weight percent, based on a total weight of the solvent composition, preferably 20 weight percent to 40 weight percent.

In another embodiment, the multinitrile solvent is contained in the solvent composition in an amount of 1 weight percent to 10 weight percent, based on a total weight of the solvent composition, preferably 2 weight percent to 5 weight percent, more preferably about 5 weight percent.

In an aspect, the total amount of mononitrile solvent, carbonate solvent, ester solvent, and/or ether solvent contained in the solvent composition is 1 wt % to 99.8 wt %, or 20 wt % to 99.8 wt %, or 30 wt % to 99 wt %, or 40 wt % to 95 wt %, or 50 wt % to 95 wt %, or 70 wt % to 90 wt %, or 75 wt % to 90 wt %, or 80 wt % to 90 wt %, based on the total weight of the solvent composition.

In an aspect, the weight ratio of the dinitrile solvent to the total amount of mononitrile solvent, carbonate solvent, ester solvent, and/or ether solvent can be 5:1 to 1:20, or 3:1 to 1:20, or 2:1 to 1:10, or 1:1 to 1:10, or 1:2 to 1:10, or 1:3 to 1:10.

In an aspect, the solvent composition comprises the carbonate solvent. In an aspect, the carbonate solvent comprises PC, EMC, or a combination thereof. In an aspect, the carbonate solvent consists of PC, EMC, or a combination thereof. In an aspect, the carbonate comprises EC or PC, and the EC or PC is contained in an amount of at least 1 weight percent, based on a total weight of the solvent composition. In an aspect, the EC or PC is contained in an amount of at least 1 wt %, at least 5 wt %, at least 10 wt %, or at least 20 wt % based on the total weight of the solvent composition. In an aspect the EC or PC is contained in an amount of 1 wt % to 60 wt %, or 5 wt % to 45 wt %, or 10 wt % to 40 wt %, based on the total weight of the solvent composition.

In an aspect, the solvent composition includes the mononitrile solvent. In an aspect, the mononitrile solvent comprises a C₂ to C₈ aliphatic mononitrile. The aliphatic group of the C₂ to C₈ aliphatic mononitrile can be a linear or branched C₂ to C₈ alkyl, alkenyl, or alkynyl group, and in an aspect, is a linear C₂ to C₈ alkyl, alkenyl, or alkynyl group. Examples of the mononitrile include methoxypropionitrile, butyronitrile, ethanenitrile, propanenitrile (proprionitrile), acetonitrile, or a combination thereof. In an aspect, the mononitrile solvent is contained in the solvent composition in an amount of 1 wt % to 95wt %, or 5 wt % to 90 wt %, or 10 wt % to 85 wt %, or 10 wt % to 75 wt %, or 20 wt % to 50 wt %, based on the total weight of the solvent composition. In an aspect, the mononitrile solvent is contained in the solvent composition in an amount of 5% to 50 wt %, or 10 wt % to 40 wt %.

In an aspect, the solvent composition comprises the dinitrile solvent and the mononitrile solvent, and the total amount of carbonate solvent, ether solvent, and ester solvent in the solvent composition is from 0.01 wt % to 10 wt %, or from 0.05 wt % to 5 wt %, or 0.1 wt % to 1 wt %, based on the total weight of the solvent composition. In an aspect, the solvent composition comprises the dinitrile solvent and the mononitrile solvent and substantially no carbonate solvent, ester solvent, or ether solvent.

In an aspect, the solvent consists of PC or EC, EMC, and ADN. In an aspect, the solvent composition comprises, or consists of 30 wt % PC or EC, 60 wt % EMC, and 10 wt % ADN.

In a preferred embodiment, the solvent composition comprises, such as consists, of PC or EC, EMC, and ADN, SN or TN. In such an embodiment, the solvent composition comprises, or consists, of PC or EC, and EMC in a weight ratio of from 30:70 to 50:50, and ADN, SN or TN in an amount of from 2 to 5 wt. % based on the weight of the electrolyte composition.

In a particularly preferred embodiment, the solvent composition comprises, such as consists, of PC, EMC, and ADN, SN or TN. In such an embodiment, the solvent composition comprises, or consists, of PC and EMC in a weight ratio of from 30:70 to 50:50, and ADN, SN or TN in an amount of from 2 to 5 wt. % based on the weight of the electrolyte composition.

In another preferred embodiment, the solvent composition comprises, such as consists, of PC, EMC, and ADN or SN. In such an embodiment, the solvent composition comprises, or consists, of PC and EMC in a weight ratio of from 30:70 to 50:50, and ADN or SN in an amount of from 2 to 5 wt. % based on the weight of the electrolyte composition. In a yet more preferred embodiment the dinitrile is SN.

In some embodiments, the electrolyte comprises a lithium salt.

In some such embodiments, the lithium salt in the electrolyte comprises LiBF₄, LiPF₆, lithium bis(fluorosulfonyl)imide (LiFSI), lithium bis(trifluoromethanesulfonyl)imide (LiTFSI), or a combination thereof and additionally or alternately lithium difluoro(oxalato)borate (LiDOFB) The concentration of the lithium salt in the (e.g., nonaqueous) electrolyte is, for example, 0.01 molar (M) to 2.0 M, 0.05 M to 1.8 M, 0.1 M to 1.6 M, 0.5 M to 1.4 M, 0.5 M to 1.3 M, or 0.8 M to 1 M′ based on the total weight of the electrolyte. In one embodiment, the lithium salt comprises 0.01 to 1 M LiBF₄ and 0.1 M to 0.3 M of LiPF₆. In another embodiment, the lithium salt comprises 0.1 to 0.3 M LiBF₄, such as 0.2 M LiBF₄. In a further embodiment, the lithium salt comprises 0.05 to 0.2 M LiDFOB, such as 0.1 M LiDFOB.

In an aspect, the electrolyte comprises 0.5 M to 3 M lithium salt and is substantially free of PF₆_{^{−}}. In an aspect, the electrolyte comprises less than 0.1 M, or less than 0.05 M, or less than 0.02 M, or less than 0.01 M, or less than 0.005 M of PF₆_{^{−}}. In an aspect, the electrolyte does not comprise PF₆_{^{−}}.

The solvent composition can be prepared by combining the dinitrile solvent and at least one of the carbonate solvent, the ester solvent, or the ether solvent. The electrolyte can be prepared by contacting the solvent composition with the lithium salt, where present, and dissolving the lithium salt in the solvent composition.

### Secondary Battery

Also disclosed is a secondary battery comprising the electrolyte described herein. In particular, the secondary battery comprises: a positive electrode; a negative electrode comprising a niobium metal oxide; a separator between the positive electrode and the negative electrode; and the electrolyte. Typically, the battery comprises one or more electrochemical cells. In general, a secondary battery refers to a battery in which the cell reactions are reversible, so the battery is typically rechargeable.

The negative electrode comprises a negative electrode active material on a current collector. The negative electrode active material comprises a niobium oxide or a niobium metal oxide. Typically, the negative active material consists essentially of a niobium oxide or a niobium metal oxide

The niobium metal oxide typically has the formula NbₓM_{y}O_{z}, where x is 2 to 34, y is 1 to 20, and z is 8 to 115, and M is Na, Mg, Al, Si, P, S, K, Ca, V, Cr, Mn, Fe, Co, Ni, Cu, Zn, As, Y, Zr, Mo, In, Sn, Sb, Ta, W, or a combination thereof. In an aspect, M is V, Cr, Mo, Ta, W, P, S, or a combination thereof. In an aspect, the niobium metal oxide comprises niobium, tungsten or molybdenum, and optionally calcium, chromium, cobalt, magnesium, manganese, nickel, potassium, phosphorus, sodium, sulfur, or a combination thereof. In an aspect, the niobium metal oxide is a niobium tungsten oxide or a niobium molybdenum oxide. In an aspect, the niobium metal oxide comprises niobium, tungsten or molybdenum, and oxygen. Examples of the niobium tungsten oxide include Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₂Mo₃O₁₄, Nb₁₄Mo₃O₄₄, Nb₁₂MoO₄₄, or a combination thereof. In an aspect, the niobium metal oxide comprises Nb₁₆W₅O₅₅.

The niobium oxide typically has the formula Nbₓ₁O_{z1}, where x1 is from 2 to 25 and z1 is from 2 to 62. Examples of niobium oxides include Nb₂O₅, NbO₂, Nb₁₂O₂₉, or Nb₂₅O₆₂, or combinations thereof.

Also mentioned is an aspect where the niobium oxide is doped to provide a compound of the formula NbₓM1_{y1}M2_{y2}O_{z}, where M1 is W or Mo, M2 is V, Cr, Mo, Ta, W, P, S, or a combination thereof, x is 2 to 34, (y1+y2) is 1 to 20, and z is 8 to 115, 0≤y1≤20 and 0≤y2≤20.

The negative electrode active material may further include an additional active material. Examples of the additional negative electrode active material include tungsten oxide, lithium titanium oxide, or a combination thereof.

The negative electrode can be formed from a negative electrode composition comprising the negative electrode active material. In addition to the negative electrode active material, the negative electrode composition can further comprise a binder, a solvent, a conductive agent, or a combination thereof. The binder can include polyvinylalcohol, carboxymethylcellulose, hydroxypropylcellulose, diacetylcellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, nylon, or a combination thereof. The conductive agent can include a conductive carbon such as carbon nanotubes, natural graphite, artificial graphite, carbon black, acetylene black, ketjen black, and carbon fibre, or a powder or fibre of a metal such as copper, nickel, aluminium, or silver.

In an aspect, the negative electrode comprises a negative electrode composition disposed on an aluminium current collector, the negative electrode composition comprising, or consisting of, Nb₁₆W₅O₅₅ as the negative active material, SBR as the binder, and conductive carbon, as the conductive agent.

Alternatively, the negative electrode current collector can include copper, nickel, stainless steel, carbon steel, titanium, or a combination thereof.

The negative electrode may be formed by coating a layer of the negative electrode composition on a negative electrode current collector, or alternatively, the negative electrode composition may be cast onto a separate support and a film exfoliated from the separate support laminated on the metal current collector. The method of preparing the negative electrode is not limited thereto, and any other method suitable for the preparation of a negative electrode may also be used.

The positive electrode comprises a positive electrode active material. The positive electrode can comprise lithium cobalt oxide (LCO), lithium nickel cobalt aluminium oxide (NCA), lithium manganese oxide (LMO), lithium nickel manganese oxide (LNMO), lithium nickel cobalt manganese oxide (NMC) (e.g., LiNi_{0.8}Co_{0.10}Mn_{0.10}O₂; NMC811), lithium iron phosphate (LFP), lithium manganese iron phosphate (LMFP), or a combination thereof. Preferably the positive electrode active material comprises LCO, NCA or NMC.

The positive electrode can be formed from a positive electrode composition comprising the positive electrode active material. In addition to the positive electrode active material, the positive electrode composition can further comprise a binder, a solvent, a conductive agent, or a combination thereof. The conductive agent can include carbon nanotubes, natural graphite, artificial graphite, carbon black, acetylene black, ketjen black, carbon fibre, a powder or fibre of a metal such as copper, nickel, aluminium, or silver, or a combination thereof. The binder in the positive electrode composition can include polyvinylalcohol (PVA), carboxymethylcellulose (CMC), hydroxypropyl cellulose, diacetyl cellulose, polyvinylchloride, carboxylated polyvinylchloride, polyvinyl fluoride, polyethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, or a combination thereof. In an aspect, the positive electrode comprises a positive electrode composition on an aluminium current collector, the positive electrode composition comprising, or consisting of, NMC or LCO as the positive electrode active material, PVDF as a binder, and carbon nanotubes, carbon black, and/or ketjen black as a conductive agent.

The positive electrode can further include a positive current collector comprising aluminium, titanium, stainless steel, carbon, or a combination thereof.

The positive electrode can be prepared in a manner similar to the method described above for the negative electrode.

The secondary battery comprises a separator between the positive and the negative electrodes. The separator is not limited and can be any separator suitable for use in a lithium-ion battery. The separator comprises a separator material that is electrically insulating, chemically non-reactive with the positive and negative active materials, chemically non-reactive with the electrolyte, and insoluble in the electrolyte. In addition, the separator material is selected such that it has a degree of porosity sufficient to allow the electrolyte to flow through during the electrochemical reaction of the cell. The separator can be a porous polymer membrane, or can be a non-woven or woven fabric. The separator can comprise, for example, polypropylene (e.g., Celgard® 2500), polyethylene, polyamide (nylon), polysulfone, polyvinyl chloride (PVC), polyvinylidine fluoride (PVDF), polyvinylidine fluoride-co-hydrofluoropropylene (PVDF-HFP), a tetrafluoroethylene-ethylene copolymer (PETFE), a chlorotrifluoroethylene-ethylene copolymer, or a combination thereof. In an aspect, the separator can comprise two or more layers of alternating materials, for example, a trilayer separator of polypropylene/polyethylene/polypropylene. The separator can be impregnated with the electrolyte.

### Method of Preparation

The cell is manufactured by providing the nonaqueous electrolyte and adding the nonaqueous electrolyte to an assembly comprising the positive electrode, the negative electrode, and the separator between the positive and negative electrodes.

The secondary battery can be of any configuration, such as a cylindrical wound cell, a prismatic cell, a rigid laminar cell, or a flexible pouch, envelope or bag cell.

The secondary battery including a niobium metal oxide as negative active material and the electrolytes disclosed herein demonstrates reduced gas production. In particular, relatively low amounts of gas are produced by the secondary battery during extended storage at a temperature of 50° C. to 70° C., or 55° C. to 65° C., or 60° C. The disclosed secondary battery has a gas generation volume of less than 10 vol %, or less than 8 vol %, or less than 5 vol %, or less than 3 vol %, or less than 1 vol %, or less than 0.1 vol %, following storage of the secondary battery for 6 days at 60° C., based on a total volume of the cell. The disclosed secondary battery also has a gas generation volume of 0.001 vol %, 0.01 vol %, or 0.1 vol % to 1 vol %, 5 vol %, or 10 vol %, based on a total volume of the cell following storage for 14 days at 60° C. In an aspect, the gas volume is less than 10% of the total cell volume following storage for 3 months at 60° C.

This disclosure is further illustrated by the following examples, which are non-limiting.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

It will be understood that when an element is referred to as being “on” another element, it can be directly on the other element or intervening elements may be present therebetween. In contrast, when an element is referred to as being “directly on” another element, there are no intervening elements present.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

“Aliphatic” or “aliphatic group” means a saturated or unsaturated linear or branched hydrocarbon group. An aliphatic group may be an alkyl, alkenyl, or alkynyl group, for example “Nitrile” or “mononitrile” means a compound having the formula R—CN, where R is a substituted or unsubstituted C₂-C₂₀ aliphatic group. “Dinitrile” means a compound having the formula CN—R—CN, where R is a substituted or unsubstituted C₂-C₂₀ aliphatic group.

“Cyclic carbonate” refers to a carbonate compound having at least one ring and in which a carbonate group (—O(C═O)O—) forms a part of the ring. “Acyclic carbonate” refers to a carbonate compound wherein a carbonate group (—O(C═O)O—) does not form a part of the ring. The acyclic carbonate may include a linear hydrocarbon chain, a branched hydrocarbon chain, or both.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl.

“Alkenyl” means a straight or branched chain, monovalent hydrocarbon group having at least one carbon-carbon double bond (e.g., ethenyl (—HC═CH₂)).

“Alkylene” means a straight or branched chain, saturated, divalent aliphatic hydrocarbon group (e.g., methylene (—CH₂—) or propylene (—(CH₂)₃—)).

“Substituted” means a compound or group substituted with at least one (e.g., 1, 2, 3, 4, 5, 6 or more) substituents independently selected from a halogen (e.g., F—, Cl—, Br—, I—), a hydroxyl, an alkoxy, a nitro, a cyano, an amino, an azido, an amidino, a hydrazino, a hydrazono, a carbonyl, a carbamyl, a thiol, a C₁ to C₆ alkoxycarbonyl, an ester, a carboxyl, or a salt thereof, sulfonic acid or a salt thereof, phosphoric acid or a salt thereof, a C₁ to C₂₀ alkyl, a C₂ to C₁₆ alkynyl, a C₆ to C₂₀ aryl, a C₇ to C₁₃ arylalkyl, a C₁ to C₄ oxyalkyl, a C₁ to C₂₀ heteroalkyl, a C₃ to C₂₀ heteroaryl (i.e., a group that comprises at least one aromatic ring, wherein at least one ring member is other than carbon), a C₃ to C₂₀ heteroarylalkyl, a C₃ to C₂₀ cycloalkyl, a C₃ to C₁₅ cycloalkenyl, a C₆ to C₁₅ cycloalkynyl, a C₅ to C₁₅ heterocycloalkyl, or a combination including at least one of the foregoing, instead of hydrogen, provided that the substituted atom's normal valence is not exceeded.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

### Statements of Invention

The following numbered paragraphs contain statements of broad combinations of technical features in accordance with various aspect of the invention disclosed herein.

1. A secondary battery, comprising:
a positive electrode;
a negative electrode comprising a niobium metal oxide;
a separator between the positive electrode and the negative electrode; and an electrolyte comprising
a solvent composition comprising a dinitrile solvent and at least one of a mononitrile solvent, a carbonate solvent, an ester solvent, or an ether solvent, wherein the dinitrile is contained in an amount of at least 0.1 weight percent, based on a total weight of the solvent composition, and
a lithium salt.

2. The secondary battery of paragraph 1, wherein the dinitrile is a C₃ to C₁₀ aliphatic linear dinitrile.

3. The secondary battery of paragraph 2, wherein the C₃ to C₁₀ aliphatic linear dinitrile comprises glutaronitrile, adiponitrile, pimelonitrile, suberonitrile, azelanitrile, sebaconitrile, or a combination thereof.

4. The secondary battery of paragraph 2, wherein the C₃ to C₁₀ aliphatic linear dinitrile is adiponitrile.

5. The secondary battery of any of paragraphs 1 to 4, wherein the dinitrile is contained in an amount of 0.2 weight percent to 50 weight percent, based on a total weight of the solvent composition.

6. The secondary battery of any of paragraphs 1 to 5, wherein the carbonate solvent comprises dimethyl carbonate, diethyl carbonate, dipropyl carbonate, methyl propyl carbonate, ethyl propyl carbonate, ethyl methyl carbonate, methyl ethyl carbonate, ethylene carbonate, propylene carbonate, butylene carbonate, monofluoroethylene carbonate, 4,4-difluoroethylene carbonate, 4,5-difluoroethylene carbonate, or a combination thereof.

7. The secondary battery of paragraph 6, wherein the carbonate solvent comprises propylene carbonate, and the propylene carbonate is contained in an amount of at least 1 weight percent, based on a total weight of the solvent composition.

8. The secondary battery of any of paragraphs 1 to 7, wherein the ester solvent comprises methyl acetate, ethyl acetate, n-propyl acetate, dimethyl acetate, methyl propionate, ethyl propionate, γ-butyrolactone, 5-decanolide, γ-valerolactone, dl-mevalonolactone, γ-caprolactone, or a combination thereof.

9. The secondary battery of any of paragraphs 1 to 8, wherein the ether solvent comprises dibutyl ether, tetraglyme, diglyme, 1,2-dimethoxyethane, 2-methyl tetrahydrofuran, tetrahydrofuran, or a combination thereof.

10 The secondary battery of any of paragraphs 1 to 9, wherein the mononitrile solvent comprises a C₂ to C₈ aliphatic mononitrile.

11. The secondary battery of paragraph 9, wherein the C₂ to C₈ aliphatic mononitrile comprises butyronitrile, ethanenitrile, proprionitrile, acetonitrile, or a combination thereof.

12. The secondary battery of paragraph 10, wherein the C₂ to C₈ aliphatic mononitrile is contained in an amount of 30 to 90 weight percent, based on a total weight of the solvent composition.

13. The secondary battery of any of paragraphs 1 to 12, wherein the lithium salt comprises LiBF₄.

14. The secondary battery of any of paragraphs 1 to 13, wherein the lithium salt is contained in the electrolyte in a concentration of 0.5 to 3 molar.

15. The secondary battery of paragraph 14, wherein the electrolyte comprises 0.01 to 0.3 molar LiBF₄.

16. The secondary battery of paragraph 14, wherein the electrolyte comprises 0.8 molar to 3 molar LiPF₆.

17. The secondary battery of paragraph 14, wherein the electrolyte comprises less than 0.1 molar PF₆_{^{−}}.

18. The secondary battery of paragraph 14, wherein the electrolyte does not comprise PF₆_{^{−}}.

19. The secondary battery of any of paragraphs 1 to 18, wherein the niobium metal oxide is Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₂Mo₃O₁₄, Nb₁₄Mo₃O₄₄, Nb₁₂MoO₄₄, or a combination thereof.

20. The secondary battery of paragraph 19, wherein the niobium metal oxide is Nb₁₆W₅O₅₅.

21. A method of manufacturing a secondary battery, the method comprising:
providing a positive electrode,
providing a negative electrode comprising a niobium metal oxide, and
providing a separator between the positive electrode and the negative electrode; and providing an electrolyte comprising
   a solvent composition comprising a dinitrile solvent and at least one of a carbonate solvent, an ester solvent, or an ether solvent, wherein the dinitrile is contained in an amount of at least 0.1 weight percent, based on a total weight of the solvent composition, and
   a lithium salt, and
contacting the positive electrode, the negative electrode, and the separator with the electrolyte to manufacture the secondary battery.

### EXAMPLES

The following examples are provided to further illustrate the present invention and are not intended to limit the scope of the invention.

### Example 1

A multi-layer pouch cell including lithium nickel cobalt aluminium oxide (LiNiₓCo_{y}Al_{z}O₂, where x≥0.8, z≤0.05 and x+y+z=1, NCA) as the positive electrode active material and the niobium tungsten oxide Nb₁₆W₅O₅₅ (NWO) as the negative electrode active material, was filled with an electrolyte containing 1 M LiPF₆ and the solvents ethylene carbonate (EC) and ethyl methyl carbonate (EMC) in a EC:EMC weight ratio of 30:70, and charged to 3 V. The electrode stack was extracted from the charged full cell and separated into individual negative electrode layers each with a capacity of ˜80 mAh. In this state, the NWO negative electrode is fully lithiated and at a potential of ˜1.1 V vs. lithium.

A first negative electrode layer (1) was not-rinsed and not placed in a pouch with fresh electrolyte, a second negative electrode layer (2) was rinsed and placed in a pouch with fresh electrolyte, and a third negative electrode layer (3) was rinsed and placed in a pouch with only 30:70 EC:EMC solvent, i.e., without LiPF₆ salt.

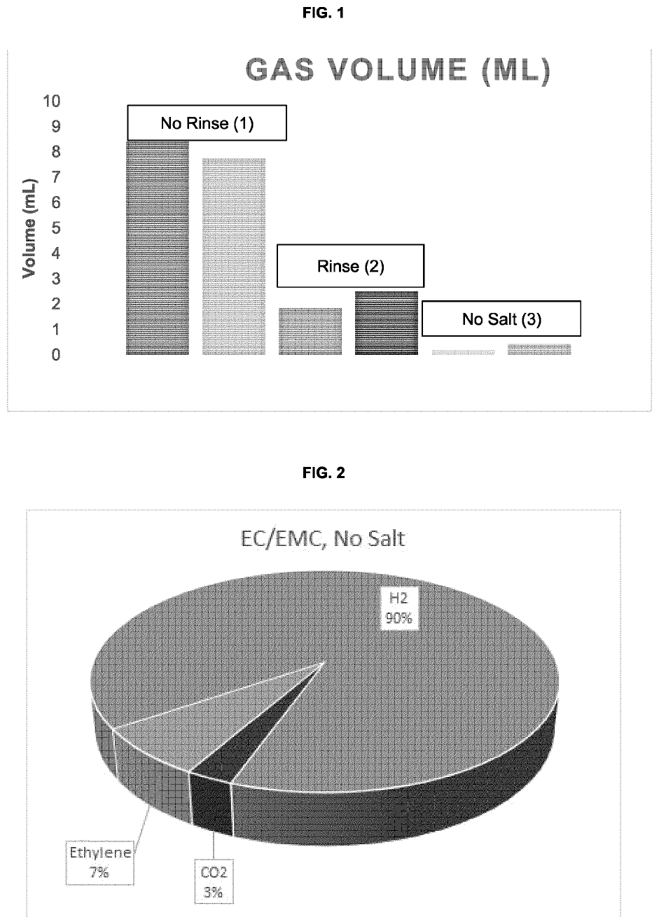

FIG. 1 shows the gas volume generated through interaction between the NWO negative electrode and the other material contained in the pouch, i.e., in the cases of layers (1) and (2) the electrolyte and in the case of layer (3) the solvent. Layer (1), which was not rinsed and therefore had a higher salt concentration, generated the highest volume of gas. Layer (2), which was rinsed and then contacted with the 30:70 EC:EMC electrolyte, produced a lower volume of gas, but the volume was still greater than that produced by layer (3). Accordingly, decreased salt concentration (1>2>3) led to decreased gas volume as the autocatalytic decomposition of LiPF₆ was less pronounced.

### Example 2

The composition of the gas produced by the no-salt pouch (third negative electrode layer) in Example 1, was measured by gas chromatography to determine the role of the solvent in gas generation, independent of the salt. The results are shown in FIG. 2, where it can be seen that a significant percentage of the gas was composed of ethylene (the gas was made up of 90% hydrogen, 3% carbon dioxide, 7% ethylene), indicating reduction of the electrolyte solvent EC. It was concluded from these experiments that a benefit could be gained by using a salt and solvent package tailored to reduce interaction with the NWO negative electrode.

### Example 3

The effect of lithium salt on gas generation was evaluated. Multi-layer 0.6 ampere-hour (Ah) NCA/NWO pouch cells were prepared and filled with one of the following electrolytes: 1 M LiPF₆ and 30:70 EC:EMC, 1 M LiFSI and 30:70 EC:EMC, or 1 M LiBF₄ and 30:70 EC:EMC. The cell was charged to 3V such that the NWO negative electrode is fully lithiated and at a potential of ˜1.1 V vs. lithium. The cell was stored in a 60° C. oven and the gas volume was periodically measured as described in Example 1.

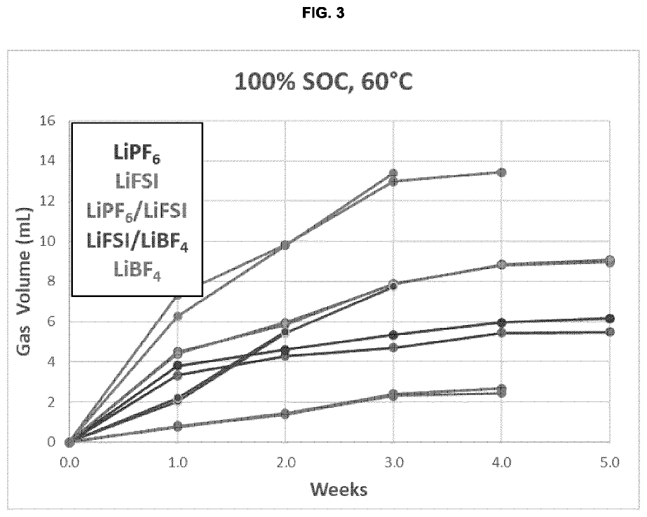

The results (FIG. 3) indicate that use of a LiBF₄ salt significantly reduces gassing compared to LiPF₆ or LiFSI.

### Example 4

The effect of electrolyte solvent on gas generation was evaluated. Multi-layer 0.16 Ah LCO/NWO pouch cells were filled with electrolyte containing 1.1 M of 20% LiBF₄/80% LiPF₆ salt in different solvents, formed, and charged to 3.35V or 3.25V. A mixture of LiBF₄/LiPF₆, rather than pure LiBF₄, was used to provide improved conductivity of the electrolyte while avoiding gassing. The solvents adiponitrile (ADN), proprionitrile (PN), and propylene carbonate (PC) were tested, based on their stability against reduction at low voltages vs. Li. The electrolyte compositions tested are shown Table 1 below. Once assembled, the pouches were stored for 14 days at 60° C. and the gas volume was measured as described in Example 1. The capacity of the cell was also measured by discharging at C/2 to 1.3 V and compared to the initial capacity.

TABLE 1

| Salt(s) | | |
|---|---|---|
| Salt Amounts (%) | Solvents | Solvent Weight Ratio |
| LiBF₄:LiPF₆ | EC:EMC | 30:70 |
| 20:80 | | |
| LiBF₄:LiPF₆ | PC:EMC:ADN | 20:40:40 |
| 20:80 | | |
| LiBF₄:LiPF₆ | EC:EMC | 50:50 |
| 20:80 | | |
| LiBF₄:LiPF₆ | PC/EMC | 50:50 |
| 20:80 | | |
| LiBF₄:LiPF₆ | PC:EMC:ADN | 45:45:10 |
| 20:80 | | |
| LiBF₄:LiPF₆ | PC:EMC:PN:ADN | 45:35:10:10 |
| 20:80 | | |
| LiPF₆ | EC:EMC | 30:70 |
| 100% | | |

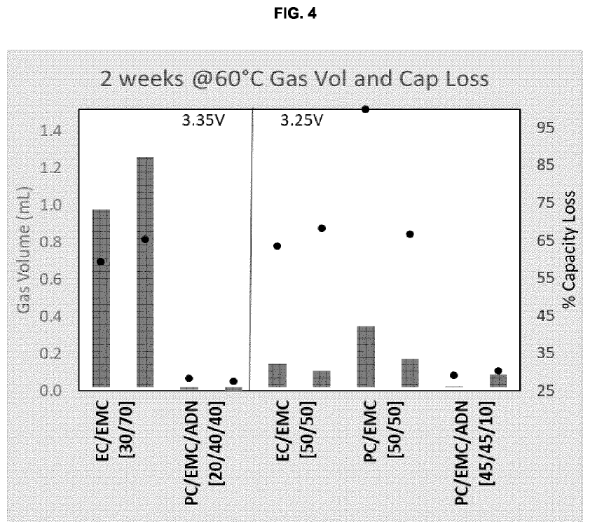

As shown in FIG. 4, cells that are charged to 3.35 V show significantly less gassing and lower capacity loss when the solvent is 20:40:40 PC:EMC:ADN, indicating stability of this solvent system. Cells including a blend of 45:45:10 PC:EMC:ADN, when charged to 3.25 V, have less gassing and lower capacity loss than cells including a blend of 30:70 EC:EMC. These cells also have less gassing and capacity loss than a 50:50 blend of PC:EMC, indicating that ADN is significantly improving solvent stability.

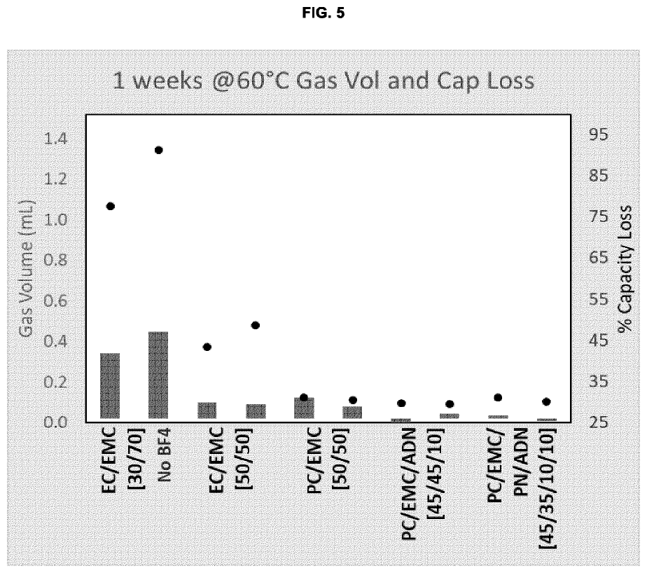

10% of EMC in the 45:45:10 PC:EMC:ADN was replaced with PN in order to reduce viscosity. The cells were stored for 7 days at 60° C., resulting in minimal gassing and capacity loss. The results in FIG. 5 show that PN improves electrochemical performance of cells containing PC and ADN.

As demonstrated in the examples, use of selected salt and solvent combinations provide reduced gassing for niobium oxide or niobium metal oxide negative electrode.

### Example 5

Additional tests were carried out to test the electrolyte composition with an alternative electrode material and alternative nitrile solvents.

In Examples 5.1 to 5.7 a multi-layer 0.12 ampere-hour (Ah) pouch cell was prepared with lithium cobalt oxide (LiCoO₂, LCO) as the positive electrode active material (cathode during discharge), niobium tungsten oxide (Nb₁₆W₅O₅₅, NWO) as the negative electrode active material (anode during discharge), a polyethylene separator and an electrolyte. The electrodes were each disposed on an aluminium current collector and assembled into a pouch cell with the separator. The pouch cells were filled with an electrolyte composition and vacuum sealed.

The electrolyte included a base solvent, which was a mixture of ethylene carbonate (EC), ethyl methyl carbonate (EMC) and/or propylene carbonate (PC) at the weight ratios set out in Table 2. Example 5.1 was prepared without any further electrolyte additives. Example 5.2 included a lithium salt (LiBF₄) as an additive present at a molar concentration of 0.2 M in the electrolyte (see Table 2). Examples 5.3 to 5.7 included a dinitrile solvent selected from adiponitrile (ADN) and succinonitrile (SN) or a trinitrile solvent (TN) which is 1,3,6-hexanetricarbonitrile. The amount of nitrile solvent included is specified in Table 2, as a percent by weight of the total electrolyte solution.

TABLE 2

| | Base Solvents | Salt | Nitrile Solvent |
|---|---|---|---|
| Example | Weight Ratio | Concentration | Concentration |
| 5.1 | EC:EMC | — | — |
| | 30:70 | | |
| 5.2 | EC:EMC | LiBF₄ | |
| | 30:70 | 0.2M | |
| 5.3 | EC:EMC | — | ADN |
| | 30:70 | | 2 wt. % |
| 5.4 | EC:EMC | — | SN |
| | 30:70 | | 2 wt. % |
| 5.5 | EC:EMC | — | TN |
| | 30:70 | | 2 wt. % |
| 5.6 | EC:EMC | — | SN |
| | 30:70 | | 5 wt. % |
| 5.7 | PC:EMC | | SN |
| | 30:70 | | 2 wt. % |

The pouch cells had initial external dimensions of 50 mm×34 mm×3 mm. An initial volume of the cell was determined by measuring the total displacement of the cell in a fluid (Archimedes' principle). The cells were then charged to 3.15V at room temperature and discharged to 1.3 V at a C-rate of C/2 to determine an initial discharge capacity.

The cell was recharged to 3.15V and stored in a 60° C. oven for 6 weeks.

The gas volume in the cells was measured after 2 weeks of storage and after 6 weeks of storage. To measure the gas volume, the cells were removed from the oven and allowed to cool to room temperature. The volume of the cell was then measured as described above. The cell volume increase (%) was calculated by comparing the cell volume at 2 weeks or 6 weeks to the initial volume.

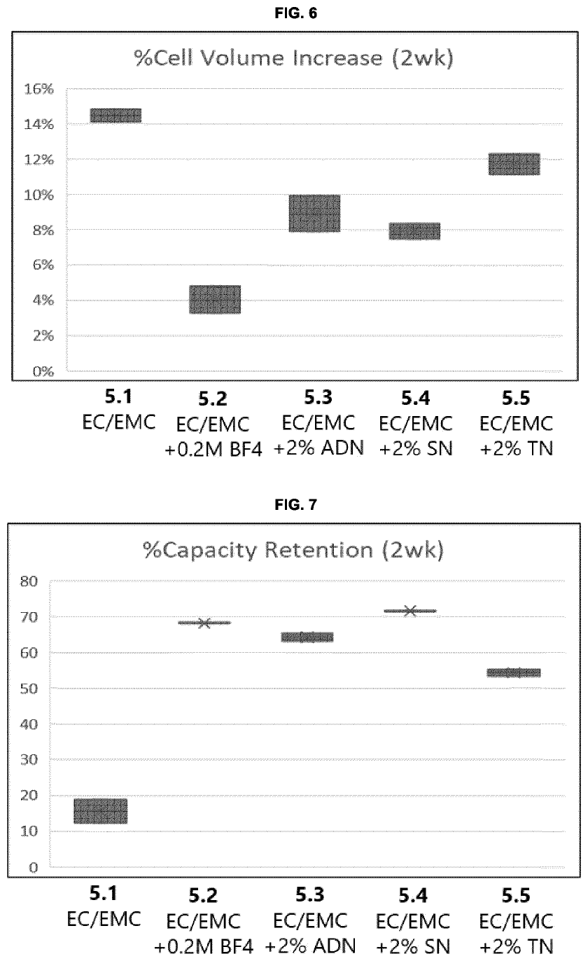

FIG. 6 shows the cell volume increase after 2 weeks of storage at 60° C. for Examples 5.1 to 5.5. The black cross corresponds to the mean average volume increase and the shaded area the standard deviation.

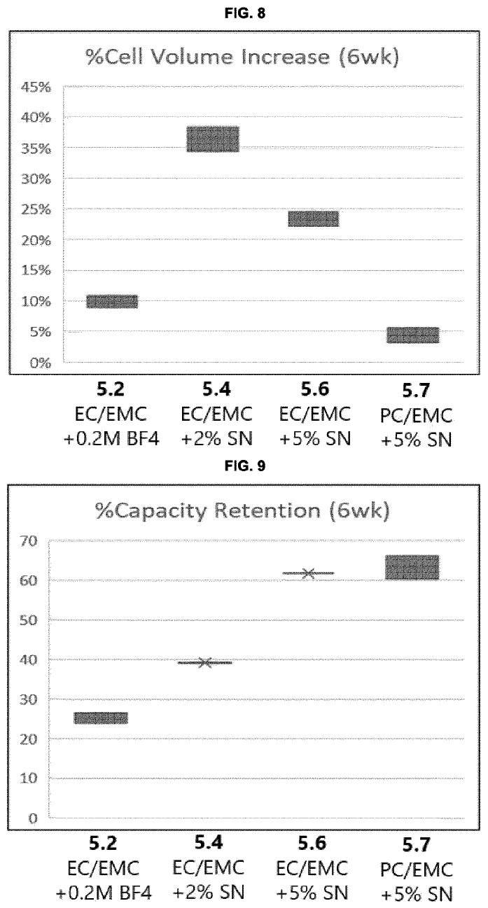

FIG. 8 shows the cell volume increase after 6 weeks of storage at 60° C. for Examples 5.2, 5.4, 5.6 and 5.7. The black cross corresponds to the mean average volume increase and the shaded area the standard deviation.

After 2 weeks, example 5.1 (no additives) had a volume increase of over 14%. In contrast, the examples 5.3, 5.4 and 5.5 (2% ADN, SN and TN) only showed a volume increase of from 8 to 12% over 2 weeks. The dinitrile and trinitrile additives are thought to supress gas generation, so preventing a large cell volume increase. The dinitriles ADN and SN are shown to supress the cell volume increase better than the trinitrile additive.

After 6 weeks, example 5.4 (2% SN) showed a volume increase of 35%, but examples 5.6 and 5.7 (both 5% SN) had a lower volume increase of about 23% and 4% respectively. Including a higher amount of dinitrile (SN) was shown to further supress gassing, and thus result in a small cell volume increase. In particular, the combination of a PC/EMC base solvent with 5% SN additive (Example 5.7) was shown to substantially reduce cell volume increase over 6 weeks to only 4%.

Example 5.2 (0.2M LiBF₄) showed a low volume increase of about 4% over 2 weeks and about 10% over 6 weeks. However, the volume increase seen for example 5.7 (PC/EMC and 5% SN) is lower and the capacity retention of the Example 5.2 is poorer than all of the dinitrile/trinitrile containing electrolytes over 6 weeks, as discussed below.

The discharge capacity of the cell was measured after 2 weeks of storage and after 6 weeks of storage. To measure the discharge capacity, the cells were removed from the oven and allowed to cool to room temperature. The cell was discharged to 1.3 V at a C-rate of C/2 to determine the discharge capacity. The discharge capacity retention (%) was calculated by comparing the 2 week or 6 week discharge capacity to the initial discharge capacity.

FIG. 7 shows the capacity retention after 2 weeks of storage at 60° C. for Examples 5.1 to 5.5. The black cross corresponds to the mean average capacity retention and the shaded area the standard deviation.

FIG. 9 shows the capacity retention after 6 weeks of storage at 60° C. for Examples 5.2, 5.4, 5.6 and 5.7. The black cross corresponds to the mean average capacity retention and the shaded area the standard deviation.

After 2 weeks, example 5.1 (no additives) had a capacity retention of about 16%. The examples 5.3, 5.4 and 5.5 (2% ADN, SN and TN) displayed a much better capacity retention of 64%, 71% and 54% respectively. In particular, the capacity retention for example 5.4 (2% SN) was higher than all other examples over 2 weeks. This is thought to be due to the dinitrile and trinitrile additives supressing electrolyte gassing.

Over 6 weeks, example 5.4 (2% SN) showed a capacity retention of 39%, while the examples 5.6 and 5.7 (both 5% SN) had a higher capacity retention of 62% and 64% respectively. Including a higher amount of dinitrile (SN) was shown to further supress gassing, resulting in improved capacity retention.

Example 5.2 (0.2M LiBF₄) showed a reasonable capacity retention over 2 weeks (69%), however after 6 weeks this decreased to only 25%. The examples including nitrile additives such as examples 5.4, 5.6 and 5.7 all had better capacity retention over the longer 6 week period (39%, 62% and 64% respectively).

The examples show that the addition of a dinitrile or trinitrile solvent to the electrolyte provides a good balance of properties (both lower cell volume increase and higher capacity retention) over longer term storage of the cell. However, the examples (e.g., example 4) also shows that the addition of both a lithium salt and a dinitrile or trinitrile solvent provides even further improvements to electrolyte gassing and capacity retention.

### References

A number of publications are cited above in order to more fully describe and disclose the invention and the state of the art to which the invention pertains. Full citations for these references are provided below. The entirety of each of these references is incorporated herein.
US 2017/0244135
JP 2013/152825
WO 2020/047228

1. A secondary battery, comprising:
a positive electrode;
a negative electrode comprising a niobium oxide or niobium metal oxide;
a separator between the positive electrode and the negative electrode; and
an electrolyte comprising
a solvent composition comprising:
a multinitrile solvent having two or more nitrile groups, and
at least one second solvent selected from the group consisting of a mononitrile solvent, a carbonate solvent, an ester solvent, and an ether solvent,
wherein the multinitrile solvent is contained in an amount of at least 0.1 weight percent, based on a total weight of the solvent composition.

2. The secondary battery of claim 1, wherein the multinitrile solvent is a dinitrile solvent or a trinitrile solvent.

3. The secondary battery of claim 1, wherein the multinitrile solvent is a C₃ to C₁₀ aliphatic dinitrile.

4. The secondary battery of claim 3, wherein the C₃ to C₁₀ aliphatic dinitrile comprises glutaronitrile, adiponitrile, pimelonitrile, suberonitrile, azelanitrile, sebaconitrile, succinonitrile or a combination thereof.

5. (canceled)

6. The secondary battery of claim 1, wherein the multinitrile solvent is a C₄ to C₁₀ aliphatic trinitrile.

7. The secondary battery of claim 6, wherein the C₄ to C₁₀ aliphatic trinitrile solvent is 1,3,6-hexanetricarbonitrile.

8. The secondary battery of claim 1, wherein the total amount of multinitrile solvent contained in the electrolyte is an amount of 2 weight percent to 40 weight percent, based on a total weight of the solvent composition.

9. The secondary battery of claim 1, wherein the total amount of multinitrile solvent contained in the electrolyte is an amount of 1 weight percent to 10 weight percent, based on a total weight of the solvent composition.

10. (canceled)

11. The secondary battery of claim 1, wherein the second solvent is a carbonate solvent.

12. The secondary battery of claim 1, wherein the carbonate solvent is dimethyl carbonate, diethyl carbonate, dipropyl carbonate, methyl propyl carbonate, ethyl propyl carbonate, ethyl methyl carbonate, methyl ethyl carbonate, ethylene carbonate, propylene carbonate, butylene carbonate, monofluoroethylene carbonate, 4,4-difluoroethylene carbonate, 4,5-difluoroethylene carbonate, or combinations thereof.

13. The secondary battery of claim 1, wherein the carbonate solvent is ethylene carbonate, ethyl methyl carbonate, propylene carbonate or combinations thereof.

14. The secondary battery of claim 13, wherein the carbonate solvent comprises a mixture of ethylene carbonate and ethyl methyl carbonate, or propylene carbonate and ethyl methyl carbonate,
wherein the weight ratio of ethylene carbonate to ethyl methyl carbonate or the weight ratio of propylene carbonate to ethyl methyl carbonate is from 30:70 to 50:50.

15.-18. (canceled)

19. The secondary battery of claim 1, wherein the second solvent is a mononitrile solvent.

20. The secondary battery of claim 19, wherein the mononitrile solvent comprises butyronitrile, ethanenitrile, proprionitrile, acetonitrile, or a combination thereof.

21. (canceled)

22. The secondary battery of claim 1, wherein the electrolyte further comprises a lithium salt.

23. The secondary battery of claim 22, wherein the lithium salt comprises LiBF₄, LiPF₆, or lithium difluoro(oxalato)borate.

24.-26. (canceled)

27. The secondary battery of claim 1, wherein the negative electrode comprises a niobium metal oxide.

28. The secondary battery of claim 1, wherein the niobium metal oxide is Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₂Mo₃O₁₄, Nb₁₄Mo₃O₄₄, Nb₁₂MoO₄₄, or a combination thereof.

29. A method of manufacturing a secondary battery, the method comprising:
providing a positive electrode,
providing a negative electrode comprising a niobium oxide or niobium metal oxide, and
providing a separator between the positive electrode and the negative electrode; and
providing an electrolyte comprising
a solvent composition comprising:
a multinitrile solvent having two or more nitrile groups, and
at least one second solvent selected from the group consisting of a mononitrile solvent, carbonate solvent, an ester solvent, or an ether solvent,
wherein the multinitrile is contained in an amount of at least _{0.1} weight percent, based on a total weight of the solvent composition, and
contacting the positive electrode, the negative electrode, and the separator with the electrolyte to manufacture the secondary battery.

30. The method of claim 29, wherein the electrolyte comprises a lithium salt, the multinitrile solvent is a dinitrile solvent, and the negative electrode comprises a niobium metal oxide.

31.-32. (canceled)
